(19) United States
(12) Patent Application Publication
(10) Pub. No.: US 2017/0076195 A1
(43) Pub. Date: Mar. 16, 2017

(54) DISTRIBUTED NEURAL NETWORKS FOR SCALABLE REAL-TIME ANALYTICS

(71) Applicant: Intel Corporation, Santa Clara, CA (US)

(72) Inventors: Shao-Wen Yang, Hillsboro, OR (US); Jianguo Li, Beijing (CN); Yen-Kuang Chen, Palo Alto, CA (US); Yurong Chen, Beijing (CN)

(21) Appl. No.: 14/849,924

(22) Filed: Sep. 10, 2015

(51) Int. Cl. G06N 3/04

(52) U.S. Cl. CPC G06N 3/04

(57) ABSTRACT

Techniques related to implementing distributed neural networks for data analytics are discussed. Such techniques may include generating sensor data at a device including a sensor, implementing one or more lower level convolutional neural network layers at the device, optionally implementing one or more additional lower level convolutional neural network layers at another device such as a gateway, and generating a neural network output label at a computing resource such as a cloud computing resource based on optionally implementing one or more additional lower level convolutional neural network layers and at least implementing a fully connected portion of the neural network.

### BACKGROUND

In computer vision and visual understanding contexts, devices may become more intelligent and responsive to users and their environments. For example, visual understanding is a demanding computational task with a set of forms, methodologies, tools, and approaches that may turn data associated with discrete elements into information that may be used to reason about the world. As computing devices have become more powerful and less costly, detection, tracking, and recognition of objects of interest has become more widespread. Such object detection, tracking, and recognition may make possible insights that may enhance the user experience when interacting with such devices.

Furthermore, distributed devices such as cameras (e.g., analog and digital surveillance cameras or mobile device cameras or the like) have become widespread. For example, surveillance cameras are common on street corners, at road intersections, in parking lots, at stores, surrounding private property, and so on. However, such cameras are underused for object detection, tracking, and recognition because the images and video attained from such cameras cannot be processed in a timely manner due to limited transmission bandwidth (e.g., the amount of data would overload the network capacity of the network including the cameras) and/or limited computational bandwidth (e.g., the amount of computation would overwhelm the computational capacity of the camera).

For example, if a computational resource remote from the camera (e.g., a cloud resource or the like) were used to perform object detection, tracking, and recognition, the networking bandwidth would not support the data transfer from the camera to the remote computational resource. Furthermore, attempts to locally perform computations for object detection, tracking, and recognition would not be supported by the local computational resources of the camera.

It may be advantageous to perform object detection, tracking, and recognition and other analytics based on data obtained via distributed devices such as cameras that have limited computational resources and limited bandwidth access to remote computational resources. It is with respect to these and other considerations that the present improvements have been needed. Such improvements may become critical as the desire to perform data analytics becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 illustrates an example neural network;

FIG. 2 illustrates an example distributed neural network framework;

FIG. 3 illustrates an example distributed neural network framework;

FIG. 4 illustrates an example camera for implementing at least a portion of a neural network;

FIG. 5 illustrates an example system for implementing at least a portion of a neural network;

FIG. 6 is a flow diagram illustrating an example process for implementing at least a portion of a neural network;

FIG. 7 is an illustrative diagram of an example system for implementing at least a portion of a neural network;

FIG. 8 is an illustrative diagram of an example system; and

FIG. 9 illustrates an example small form factor device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, or such embodiments, or examples, etc., indicate that the implementation, embodiment, or example described may include a particular feature, structure, or characteristic, but every implementation, embodiment, or example may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to affect such feature, structure, or characteristic in connection with other implementations whether or not explicitly described herein.

Methods, devices, apparatuses, computing platforms, and articles are described herein related to distributed neural networks.

As described above, data such as image and video data attained from distributed devices such as cameras is underused for data analytics such as object detection, tracking, and recognition due to limited computational bandwidth and/or limited transmission bandwidth. In some embodiments discussed herein, an end-to-end distributed neural network may be provided for real-time data analytics such as image and/or video analytics. Such analytics may provide or include segmentation, object detection, tracking, recognition, or the like and such a distributed neural network may be scalable (e.g., to increases in sensors, cameras, types of objects detected, and the like). Furthermore, the distributed neural network may include any suitable neural network such as a convolutional neural network (CNN), a deep neural network (DNN), recurrent convolutional neural network (RCNN), or the like.

In some embodiments, a distributed device including a sensor such as an image sensor (e.g., an internet protocol camera or the like) may generate sensor data such as image data (e.g., via a camera module) representative of an environment, scene, or the like. As used herein, sensor data may include any data generated via a sensor such as area monitoring data, environmental monitoring data, industrial monitoring data, or the like. As used herein, image data may include any suitable still image data, video frame data, or the like. The distributed device may include a hardware accelerator to implement one or more lower level neural network layers such as convolutional layers, sub-sampling layers, and/or fully connected layers to generate feature maps (e.g., convolutional neural network feature maps or the like) associated with the sensor data. The distributed device such as a camera or the like may transmit the feature maps to a gateway or a cloud computing resource or the like. As discussed herein, a distributed device or devices may attain sensor data for processing via a distributed neural network. Example embodiments are provided herein with details associated with cameras and image data for the sake of clarity of presentation. However, any sensor data attained or generated via any suitable distributed device or devices may be processed using the techniques, systems, devices, computing platforms, and articles discussed herein.

In embodiments where the device transmits the feature maps to a gateway, the gateway may implement one or more additional lower level neural network layers to generate feature maps (e.g., convolutional neural network feature maps or the like) and transmit the feature maps to a cloud computing resource or the like. In either embodiment, the cloud computing resource may receive the feature maps (e.g., from the distributed device or the gateway) and the cloud computing resource may optionally implement one or more additional lower level neural network layers to generate feature maps and the cloud computing resource may implement a fully connected portion (e.g., a fully connected multilayer perceptron portion of the neural network) to the received or internally generated feature maps to generate output labels (e.g., object detection labels) or similar data. Such output labels or the like may be transmitted to user interface devices for presentment to users, stored for use by other processes, or the like.

Furthermore, in some embodiments, such neural network implementations having lower level neural network layers and a fully connected portion may implement a shared lower level neural network feature maps format such that the same format of feature maps may be generated at one or more of the lower levels of the neural network. Such feature maps having the same format may be used for different types of object detection or output labeling or the like based on implementation of a specialized fully connected portion of the neural network. For example, multiple object detections (e.g., attempting to detect a variety of objects such as automobiles, faces, human bodies, and so on) may be performed on the same feature maps and/or different object detections may be performed on feature maps of the same format received from different source devices (e.g., cameras and/or gateways). In some embodiments, such neural network implementations having lower level neural network layers with a shared format and specialized fully connected portions be implemented at a single device or system such as a cloud computing resource or cloud system or the like.

Such techniques may provide a framework for scalable real-time data analytics. The techniques discussed herein may advantageously partially offload intensive computations from a shared computing environment such as a cloud computing resource or resources to a gateway and/or distributed device such as a camera or video camera or the like. Such techniques may reduce the communications bandwidth requirement from the distributed device to the gateway or cloud computing resources (e.g., as transmitting feature maps may require less bandwidth in comparison to transmitting image or video data even with video compression techniques). Furthermore, such techniques may provide a shared lower level network layer format that may limit the memory needed at the distributed device to implement the lower level layer(s) of the neural network and provide data that may be useable for a diverse range of segmentation tasks, object detection or recognition tasks (e.g., face detection, pedestrian detection, auto detection, license plate detection, and so on), or the like. Such multiple models for specific object detection or the like may be stored at the cloud computing resource (e.g., and not at the distributed device where memory storage is limited).

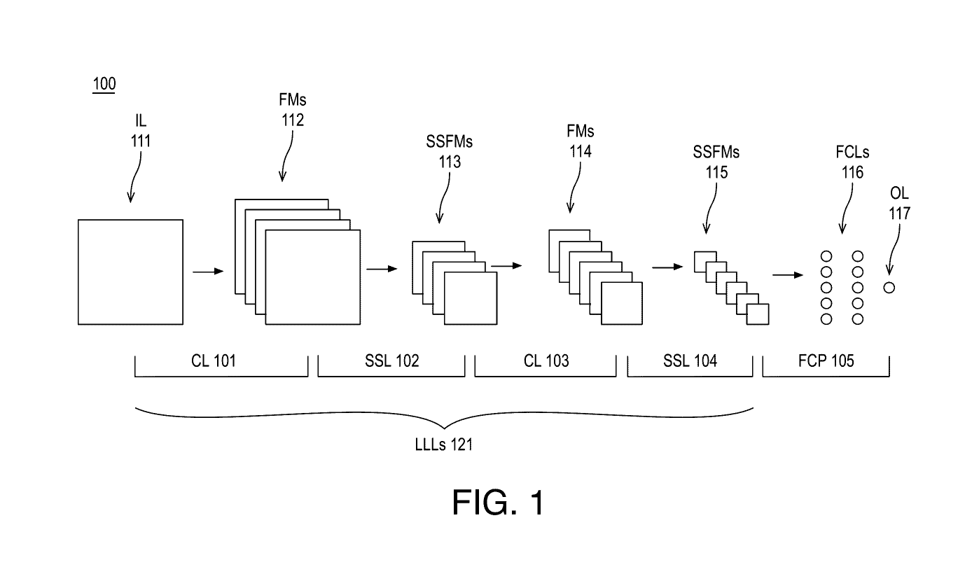

FIG. 1 illustrates an example neural network 100, arranged in accordance with at least some implementations of the present disclosure. As shown in FIG. 1, neural network 100 may include lower level layers (LLLs) 121, which may include a convolutional layer (CL) 101, a sub-sampling layer (SSL) 102, a convolutional layer (CL) 103, and a sub-sampling layer (SSL) 104, and a fully connected portion (FCP) 105. As shown, neural network 100 may receive an input layer (IL) 111, which may include any suitable input data such as sensor data or image data or the like. As used herein, sensor data may include any data generated via a sensor such as area monitoring data, environmental monitoring data, industrial monitoring data, or the like. As used herein, image data may include any suitable still image data, video frame data, or the like in any suitable format. In some examples, input layer 111 may include normalized image data in the red-green-blue color space (e.g., such that input layer 111 may include 3 color planes, R, G, and B). However, any suitable input data may be provided to neural network 100. As discussed, in other examples, input layer 111 may include sensor data such as area monitoring data, environmental monitoring data, industrial monitoring data, or the like.

As shown, convolutional layer 101 of lower level layers 121 may receive input layer 111 and convolutional layer 101 may generate feature maps (FMs) 112. Convolutional layer 101 may generate feature maps 112 using any suitable technique or techniques. For example, convolutional layer 101 may apply convolution kernels, which may be convolved with input layer 111. In some examples, such convolution kernels may be characterized as filters, convolution filters, convolution operators, or the like. Such convolution kernels or operators may extract features from input layer 111. For example, such convolution kernels or operators may restrict connections between hidden units and input units of input layer 111, allowing connection to only a subset of the input units of input layer 111. In some examples, each hidden unit may connect to only a small contiguous region of pixels in input layer 111. Such techniques may provide local features that may be learned at one part of an input image (e.g., during the training of neural network 100) and applied or evaluated at other parts of the image via input layer 111 (e.g., during the implementation neural network 100).

Also as shown, sub-sampling layer 102 of lower level layers 121 may receive feature maps 112 and sub-sampling layer 102 may generate sub-sampled feature maps (SSFMs) 113. Sub-sampling layer 102 may generate sub-sampled feature maps 113 using any suitable technique or techniques. In some examples, sub-sampling layer 102 may apply max-pooling to feature maps 112. For example, max-pooling may provide for non-linear downsampling of feature maps 112 to generate sub-sampled feature maps 113. In some examples, sub-sampling layer 102 may apply max-pooling by portioning feature maps 112 into a set of non-overlapping portions and providing a maximum value for each portion of the set of non-overlapping portions. Such max-pooling techniques may provide a form of translation invariance while reducing the dimensionality of intermediate representations, for example.

As used herein, the term convolutional neural network feature maps is intended to include any feature map generated based on the implementation of a convolutional layer of a neural network such as a convolutional neural network, any feature map based on an implementation of a sub-sampling of a feature map generated based on the implementation of a convolutional layer of a neural network such as a convolutional neural network, any other downsampling or the like of such a feature map based on the implementation of a convolutional layer of a neural network such as a convolutional neural network, or the like. For example, the term convolutional neural network feature maps may include feature maps 112, sub-sampled feature maps 113, or any other feature maps or sub-sampled feature maps discussed herein.

Sub-sampled feature maps 113 may be provided to convolutional layer 103, which may generate feature maps (FMs) 114 using any suitable technique or techniques such as those discussed with respect to convolutional layer 101. Furthermore, sub-sampling layer 104 may receive feature maps 114 and sub-sampling layer 104 may generate sub-sampled feature maps (SSFMs) 115 using any suitable technique or techniques such as those discussed with respect to sub-sampling layer 102.

As shown, lower level layers 121 of neural network 100 may include, in some embodiments, interleaved convolutional layers 101, 103 and sub-sampling layers 102, 104. In the illustrated example, neural network 100 includes two convolutional layers 101, 103 and two sub-sampling layers 102, 104. However, lower level layers 121 may include any number of convolutional layers and sub-sampling layers such as three convolutional layers and sub-sampling layers, four convolutional layers and sub-sampling layers, five convolutional layers and sub-sampling layers, or more. As is discussed further herein, such convolutional layers and sub-sampling layers may be distributed to form an end-to-end distributed heterogeneous neural network to provide object label 117 based on input layer 111. Furthermore, in the illustrated example, feature maps 112 and sub-sampled feature maps 113 include four maps and feature maps 114 and sub-sampled feature maps 115 include six maps. However, the feature maps and sub-sampled feature maps may include any number of maps such as one to 400 maps or more. In some examples, the feature maps and/sub-sampled feature maps may be concatenated to form feature vectors or the like.

Sub-sampled features maps 115 may be provided to fully connected portion 105 of neural network 100. Fully connected portion 105 may include any suitable feature classifier such as a multilayer perceptron (MLP) classifier, a multilayer neural network classifier, or the like. As shown, fully connected portion 105 may include fully connected layers (FCLs) 116 and fully connected portion 105 may generate an object label (OL) 117. For example, fully connected portion 105 may receive sub-sampled features maps 115 as an input vector or the like and fully connected portion 105 may provide fully connected and weighted network nodes with a final layer to provide softmax functions or the like. Fully connected portion 105 may include any number of fully connected layers 116 such as two layers, three layers, or more. As is discussed further herein, fully connected portion 105 may implement a specialized fully connected portion based on sub-sampled feature maps 115, which may have a shared format. In some embodiments, fully connected portion 105 may be implemented via a pre-trained model. Furthermore, in some embodiments, multiple fully connected portions may be implemented based on sub-sampled feature maps 115 with each fully connected portion performing a particular object detection such as face detection, pedestrian detection, auto detection, license plate detection, and so on. For example, each fully connected portion may have a different, specialized pre-trained model. In other embodiments, the fully connected portions may perform segmentation, object recognition, data analytics, or the like.

As discussed, in some embodiments, fully connected portion 105 may generate object label 117. Object label 117 may be any suitable object label or similar data indicating a highest probability label based on the application of fully connected portion 105 to sub-sampled features maps 115. For example, fully connected portion 105 may have a final layer with 100 to 1,000 or more potential labels and object label 117 may be the label associated with the highest probability value potential labels. In some examples, object label 117 may include multiple labels (e.g., the three most likely labels or the like), probabilities associated with such label or labels, or similar data.

As discussed, neural network 100 may include lower level layers 121 followed by fully connected portion 105. Such a structure may provide feature extraction (e.g., via lower level layers 121 including interleaved convolutional layers and sub-sampling layers) and classification based on such extracted features (e.g., via fully connected portion 105). Furthermore, neural network 100 may be distributed to form an end-to-end distributed neural network.

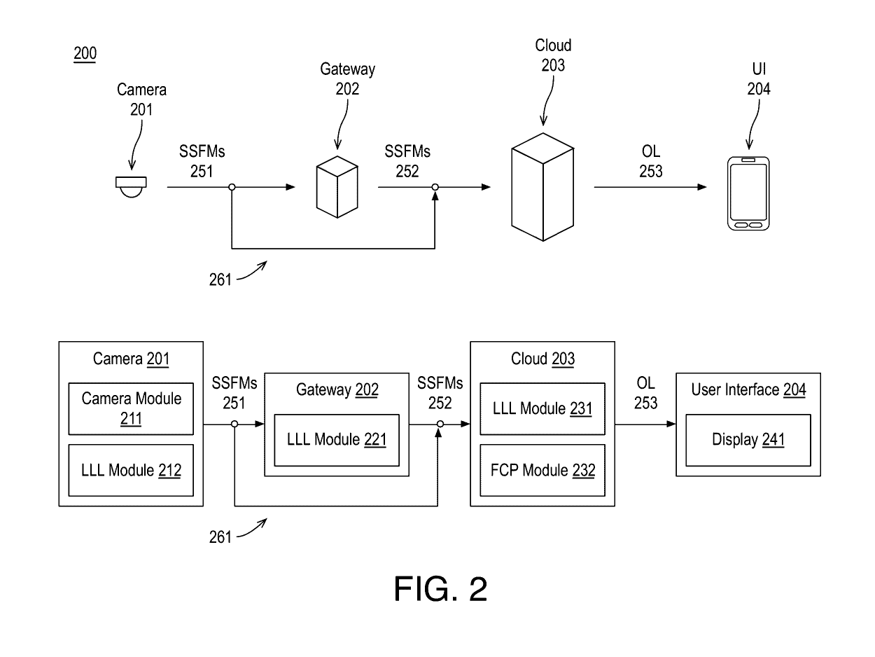

FIG. 2 illustrates an example distributed neural network framework 200, arranged in accordance with at least some implementations of the present disclosure. As shown in FIG. 2, distributed neural network framework 200 may include a camera 201 having a camera module 211 and a lower level layer (LLL) module 212, a gateway 202 having a lower level layer (LLL) module 221, a cloud computing resource (cloud) 203 having a lower level layer (LLL) module 231 and a fully connected portion (FCP) module 232, and a user interface device (UI) 204 having a display 241. As shown via bypass 261, in some embodiments, gateway 202 may not be included in distributed neural network framework 200.

As shown, camera 201 may include camera module 211 and lower level layer module 212. In the illustrated example, distributed neural network framework 200 includes camera 201. However, distributed neural network framework 200 may include any device or node having a sensor that may generate sensor data as discussed herein. Such sensor data may be used to generate sub-sampled feature maps as discussed herein. In such examples, the device or devices may include a sensor module or the like and a lower level layer module to generate sub-sampled feature maps. Furthermore, distributed neural network framework 200 may include any number and types of suitable distributed devices including sensors such as still image cameras, video cameras, or any other devices such as sensors or the like that may attain image or sensor data and provide neural network feature maps such as sub-sampled feature maps (SSFMs) 251. As used herein, the term camera is meant to include any device that may attain sensor data, including, but not limited to, image data, and provide neural network feature maps such as sub-sampled feature maps 251. Furthermore, as discussed, although illustrated with respect to an embodiment implementing camera 201, the techniques and systems discussed herein may be implemented via any suitable device having a sensor that may generate sensor data. In some embodiments, camera 201 may be an internet protocol camera, a smart camera, or the like. Camera module 211 may include any suitable device or devices that may attain image data such as an image sensor or the like. In some embodiments, camera module 211 may include image processing capabilities via an image pre-processor, or the like. Camera module 211 may provide such image data as an input layer (e.g., input layer 111) to a distributed neural network, for example.

Lower level layer module 212 may receive such sensor or image data (e.g., input layer data) and lower level layer module 212 may implement any number of lower level neural network layers such as a single lower level convolutional layer, a single lower level convolutional layer and a single sub-sampling layer, or two or more interleaved convolutional and sub-sampling layers to generate sub-sampled feature maps 251. As shown, camera 201 may provide sub-sampled feature maps 251 to gateway 202 or cloud computing resource 203. In the illustrated example, camera 201 provides sub-sampled feature maps 251. In other examples, camera 201 may provide an output from a different layer of a neural network such as feature maps from a convolutional layer. However, transmission of sub-sampled feature maps 251 may be advantageous as offering smaller size and therefore lower transmission bandwidth requirements. As discussed further herein, in some examples, sub-sampled feature maps 251 may have a shared lower level convolutional neural network feature maps format such that any type of specific object detection may be performed based on such sub-sampled feature maps 251 (e.g., via a specialized fully connected portion and/or specialized lower level layers of the neural network). Camera 201 may transmit sub-sampled feature maps 251 to gateway 202 or cloud computing resource 203 using any suitable communications interface such as a wireless communications interface.

In embodiments including gateway 202, gateway 202 may receive sub-sampled feature maps 251 and gateway 202 may, via lower level layer module 221, generate sub-sampled feature maps 252. Such sub-sampled feature maps 252 may be generated using any suitable technique or techniques. Gateway 202 may be any suitable network node, network video recorder (NVR) gateway, edge gateway, intermediate computational device, or the like. In some embodiments, as discussed with respect to camera 201, lower level layer module 221 may implement any number of lower level neural network layers such as a single lower level convolutional layer, a single lower level convolutional layer and a single sub-sampling layer, or two or more interleaved convolutional and sub-sampling layers to generate sub-sampled feature maps 252. Furthermore, as discussed, in some embodiments, sub-sampled feature maps 252 may have a shared lower level convolutional neural network feature maps format. In other embodiments, sub-sampled feature maps 252 may be specialized maps associated with a specific object detection. For example, gateway 202 may have the storage and processing bandwidth available to store and implement multiple specific object detection models as well as the capability to update or upgrade such models over time. As shown, gateway 202 may transmit sub-sampled feature maps 252 to cloud computing resource 203 via any suitable communications interface.

Cloud computing resource 203 may receive sub-sampled feature maps 251 and/or sub-sampled feature maps 252 and cloud computing resource 203 may generate object label 253. Cloud computing resource 203 may generate object label 253 using any suitable technique or techniques. In some examples, cloud computing resource 203 may, via lower level layer module 231, implement any number of lower level neural network layers such as a single lower level convolutional layer, a single lower level convolutional layer and a single sub-sampling layer, or two or more interleaved convolutional and sub-sampling layers to generate sub-sampled feature maps (not shown). Such sub-sampled feature maps generated via lower level layer module 231 may have a shared lower level convolutional neural network feature maps format or such sub-sampled feature maps may be specialized maps associated with a specific object detection. For example, as discussed with respect to gateway 202, cloud computing resource 203 may have the storage and processing bandwidth available to store and implement multiple specific object detection models as well as the capability to update or upgrade such models over time.

Furthermore, cloud computing resource 203 may, via fully connected portion module 232 implement a fully connected portion (e.g., fully connected portion 105 or the like) of distributed neural network framework 200 to generate object label 253. Fully connected portion module 232 may generate object label 253 using any suitable technique or techniques. For example, fully connected portion module 232 may implement any characteristics of fully connected portion 105 of neural network 100 and object label 253 may have any characteristics discussed with respect to object label 117.

In some embodiments, cloud computing resource 203 may transmit object label 253 to user interface device 204. User interface device 204 may present object label 253 or related data via display 241, for example. User interface device 204 may be any suitable form factor device such as a computer, a laptop computer, a smart phone (as illustrated in FIG. 2), a tablet, a wearable device, or the like. In some embodiments, cloud computing resource 203 may retain object label 253 for use via other processes (e.g., object tracking or recognition or the like) implemented via cloud computing resource 203.

As shown, in some examples, distributed neural network framework 200 may include a cloud computing resource 203. However, distributed neural network framework 200 may include any computing device, system, or the like capable of implementing to generate object label 253 having any suitable form factor such as a desktop computer, a laptop computer, a mobile computing device, or the like. As discussed, in some examples, distributed neural network framework 200 may provide a shared lower level format and specialized fully connected portion. In some examples, such a shared lower level format may be implemented to provide a scalable end-to-end heterogeneous distributed neural network framework.

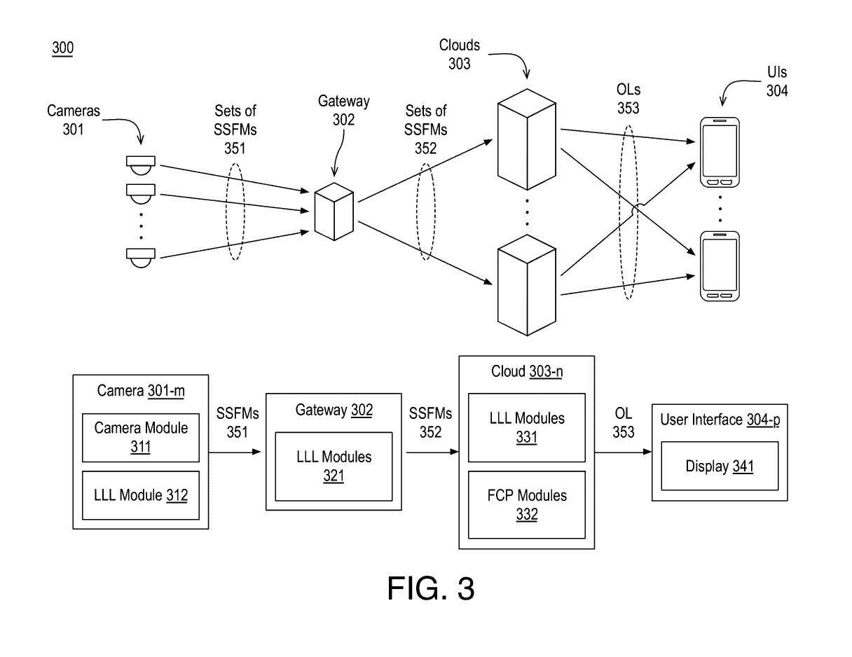

FIG. 3 illustrates an example distributed neural network framework 300, arranged in accordance with at least some implementations of the present disclosure. As shown in FIG. 3, distributed neural network framework 300 may include cameras 301 (e.g., any number of cameras including camera 301-m) each or some having a camera module 311 and a lower level layer (LLL) module 312, a gateway 302 having one or more lower level layer (LLL) modules 321, cloud computing resources (clouds) 303 (e.g., any number cloud computing resources including cloud 303-n) each or some having one or more lower level layer module 321 and/or one or more fully connected portion (FCP) modules 332, and user interface devices (UIs) 304 (e.g., any number of user interface devices including user interface 304-p) each or some having a display 341.

In some embodiments, gateway 302 may not be included in neural network framework 300. In such embodiments, sets of sub-sampled feature maps (SSFMs) 351 may be provided directly to cloud computing resources 303. Furthermore, in embodiments including gateway 302, one or more sets of sub-sampled feature maps 351 may be provided directly to cloud computing resources 303 (e.g., gateway 302 may be bypassed). As shown via FIG. 3, distributed neural network framework 300 may provide a scalable end-to-end heterogeneously distributed framework for data analytics such as image and/or video analytics.

Cameras 301 may include any number and types of cameras each having camera module 311 to attain image data (e.g., input layer data) and lower level layer module 312 to generate sub-sampled feature maps 351 as discussed with respect to camera 201 of FIG. 2. Furthermore, as discussed with respect to FIG. 2, although illustrated with cameras 301, distributed neural network framework 300 may include any devices having sensors that generate sensor data. In such examples, the device or devices may include sensor modules to generate sensor data and lower level layer modules to generate sub-sampled feature maps. In such examples, the devices may be characterized as distributed devices or nodes or the like. In some embodiments, each of cameras 301 may generate and transmit one or more sub-sampled feature maps 351 (e.g., a set of sub-sampled feature maps) to gateway 302 and/or cloud computing resources 303. In some embodiments, each set of sets sub-sampled feature maps 351 may have a common or shared lower level convolutional neural network feature maps format. Such a common or shared format may have any suitable characteristic or characteristics such that subsequent lower level neural network layers and/or a subsequent fully connected portion may utilize each set of sub-sampled feature maps to generate an associated object label or similar data. For example, the common or shared format may provide for a number of feature maps, the characteristics of such feature maps, the format of such feature maps, and so on. In some examples, the common or shared format may be characterized as a shared lower level format, a common lower level neural network format, a generalized feature map format, or the like.

Such a common or shared format may provide for a set of neurons or the like implemented via cameras 301 that may serve multiple different applications using the same data (e.g., each set of sets sub-sampled feature maps 351) and thereby provide common building blocks for object recognition tasks or the like. Such data may be used for multiple types of object detection (e.g., via specific lower level layers and/or specific fully connected portions implemented via gateway 302 and/or cloud computing resources 303). Such a common or shared format may provide reusability of the onboard computation resources of cameras 301 with limited computation and storage (e.g., as multiple models and formats do not need to be supported). For example, if cameras 301 were to provide two lower level formats or models, cameras 301 would require more computational power and memory storage than providing one lower level format or model, if cameras 301 were to provide ten lower level formats or models, cameras 301 would require more computational power and memory storage than providing nine lower level formats or models and so on. Furthermore, with a shared or common format, no upgrades or training may be needed at cameras 301, which may save implementation complexity. In some embodiments, the same lower level data may be used to perform face detection, pedestrian detection, automobile detection, license plate detection, and so on. Furthermore, such a common or shared format may offer the advantage of necessitating only one model to be saved via each of cameras 301 to implement lower level layer module 312, which may require limited storage capacity of each of cameras 301.

In embodiments including gateway 302, one or more of sets of sub-sampled feature maps 351 may be received at gateway 302 and gateway 302, via one or more of lower level layer modules 321 may generate sets of sub-sampled feature maps (SSFMs) 352. In some examples, one, some, or all sets of sub-sampled feature maps 352 may also have a common or shared lower level convolutional neural network feature maps format. In other examples, one, some, or all sets of sub-sampled feature maps 352 may have different formats such that specific object detection feature extraction may be performed. For example, one or more of lower level layer modules 321 may generate common or shared format sub-sampled feature maps and one or more of lower level layer modules 321 may generate object detection specific sub-sampled feature maps. As shown, sub-sampled feature maps 352 may be provided to one or more of cloud computing resources 303.

Cloud computing resources 303 may receive sets of sub-sampled feature maps 351 and/or sets of sub-sampled feature maps 352. Cloud computing resources 303 may generate object detection labels 353 based on the received sets of sub-sampled feature maps. As shown, each of cloud computing resources 303 may include one or more lower level layer (LLL) modules 331. As discussed with respect to gateway 302, one or more of lower level layer modules 331 may generate common or shared format sub-sampled feature maps and one or more of lower level layer modules 331 may generate object detection specific sub-sampled feature maps. Such sub-sampled feature maps (not shown), if generated, may be provided to fully connected portion modules 332, which may each implement a fully connected portion of a neural network to generate an object label of object labels 353.

For example, one, some, or all of fully connected portion modules 332 may apply a fully connected portion of a neural network based on a set of sub-sampled feature maps having a shared format. Each of the implemented fully connected portion modules 332 may thereby generate an object label such that one or more object labels may be generated for the same set of sub-sampled feature maps. Such multiple applications of object detection may be performed for any or all received sets of sub-sampled feature maps. For example, if a cloud computing resource implements three object detection applications (e.g., face, pedestrian, and auto) and receives twelve sets of sub-sampled feature maps, the resource may generate 36 object labels (e.g., some of which may be null or empty or the like). Furthermore, such object detection applications may be distributed across cloud computing resources using any suitable technique or techniques such that cloud computing resources may provide redundancy or the like.

As discussed, in some examples, the sub-sampled feature maps may be specific to a particular object detection application. In such examples, the specific sub-sampled feature maps may be provided to a compatible fully connected portion module of fully connected portion modules 332 to generate an object label of object labels 353. As shown, such object labels 353 may be provided to any number of user interface devices 304. In the illustrated example, user interface devices 304 are smart phones. However, user interface devices 304 may be any suitable devices having any suitable form factor such as desktop computers, laptop computers, tablets, wearable devices or the like. Cloud computing resources 303 may transmit labels 353 to any combination of user interface devices 304. Each or some of user interface devices 304 may present received object labels 353 or related data via display 341. In some embodiments, cloud computing resources 303 may retain object labels 353 for use via other processes (e.g., object tracking or recognition or the like) implemented via cloud computing resources 303.

As discussed, distributed neural network framework 300 may provide a scalable end-to-end heterogeneously distributed framework for data analytics such as image and/or video analytics. Such a framework may be implemented or utilized in a variety of contexts such as object detection, object tracking, object recognition, device security, building security, surveillance, automotive driving, and so on. For example, a user interface device may be coupled to a camera via distributed neural network framework 300 to provide any such functionality.

Furthermore, such distributed neural network frameworks may offload computation from cloud computing resources or the like to distributed devices such as cameras and or gateways as well as reduce transmission bandwidth requirements from the distributed devices to the gateway and/or cloud computing resources or the like. Furthermore, the shared or common lower level format or design for format maps and/or sub-sampled format maps may reduce the computational requirements and/or model size stored on the distributed devices such as cameras. Such common lower format feature maps or sub-sampled feature maps may be used by specific fully connected portions of the neural network to apply different types of object detection or the like. The discussed neural networks such as convolutional neural networks and deep learning neural networks provide powerful and sophisticated data analytics. By providing the distributed neural network frameworks discussed herein, such neural networks may be effectively implemented across heterogeneous devices to provide data analytics such as image and/or video analytics. In some embodiments, such data analytics may be provided in real-time. In some embodiments, image and/or video analytics may provide, for example, reliable and efficient prediction or detection of any number of object categories.

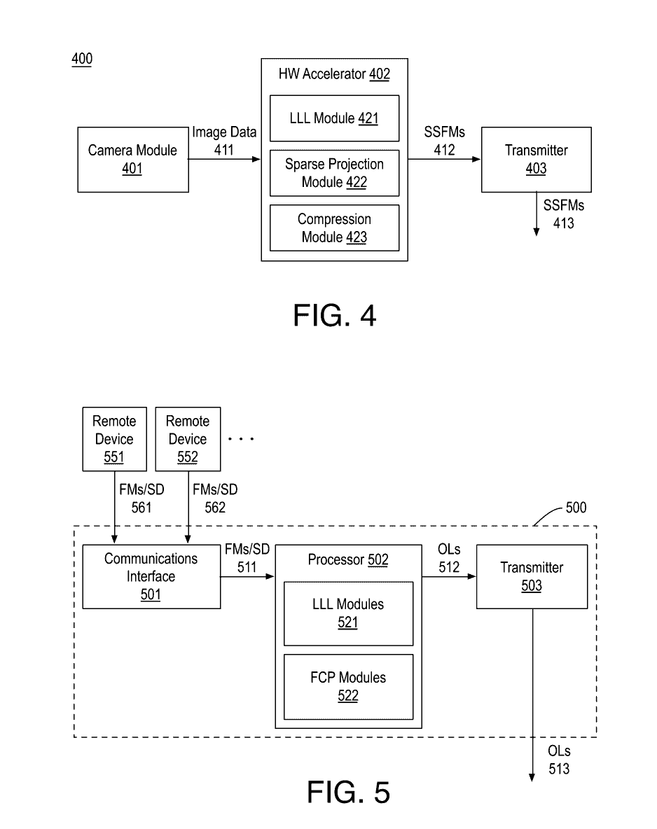

FIG. 4 illustrates an example camera 400 for implementing at least a portion of a neural network, arranged in accordance with at least some implementations of the present disclosure. For example, camera 400 may be implemented as camera 201, one or more of cameras 301, or any other camera or distributed device as discussed herein. As shown in FIG. 4, camera 400 may include a camera module 401, a hardware (HW) accelerator 402 having a lower level layer (LLL) module 421, a sparse projection module 422, a compression module 423, and a transmitter 403. In some embodiments, camera 400 may be an internet protocol (IP) camera. Camera module 401 may include any suitable may include any suitable device or devices that may attain image data such as an image sensor, an image pre-processor, or any other devices discussed herein. As shown, camera module 401 may attain an image or video of a scene and camera module 401 may generate image data 411. Image data 411 may include any suitable image or video frame data or the like as discussed herein.

As discussed, in other embodiments, distributed devices including sensors or sensor modules may be implemented via distributed neural network frameworks 200, 300. In such embodiments, a distributed device may include a sensor or sensor module to generate sensor data, a hardware accelerator having a lower level layer module, a sparse projection module, a compression module, and a transmitter analogous to those components as illustrated in FIG. 4 and as discussed herein. Such components are discussed with respect to image data for the sake of clarity of presentation.

As shown, image data 411 may be provided to hardware accelerator 402, which may generate sub-sampled feature maps (SSFMs) 412. As shown, in some embodiments, hardware accelerator 402 which may generate sub-sampled feature maps 412. However, hardware accelerator 402 may generate any feature maps discussed herein such as convolutional neural network feature maps or the like. Hardware accelerator 402 may generate sub-sampled feature maps 412 or the like using any suitable technique or techniques such as via implementation of one or more interleaved convolutional layers and sub-sampling layers as discussed herein. Hardware accelerator 402 may include any suitable device or devise for implementing lower level layer module 421, sparse projection module 422, and/or compression module 423. In some embodiments, hardware accelerator 402 may be a graphics processor, a digital signal processor (DSP), a field-programmable gate array (FPGA), an application specific integrated circuit (ASIC), or the like.

As discussed, in the distributed neural network frameworks described herein, computations may be offloaded from a cloud computing resource to camera 400 or the like. For example, in some neural network implementations, most of the computation may be spent in the first two or three interleaved convolutional layers and sub-sampling (e.g., max-pooling) layers. An example distribution of computations may include the first convolutional layer and subsampling layer requiring 60% of the computational requirement, the second convolutional layer and subsampling layer requiring 25% of the computational requirement, and the remaining neural network requiring 15% of the computational requirement. In such contexts, providing hardware accelerator 402 via camera 400 (e.g., providing onboard hardware acceleration for camera 400) may be advantageous in implementing the distributed neural network frameworks described herein.

Furthermore, in some embodiments, hardware accelerator 402 may implement sparse projection to the interleaved one or more convolutional layers and sub-sampling layers to decrease the processing time associated with the interleaved one or more convolutional layers and sub-sampling layers implemented via camera 400. Sparse projection module 422 may provide such sparse projection acceleration using any suitable technique or techniques. For example, sparse projection module 422 may estimate a sparse solution to the convolution kernels applied via convolutional layers 102, 104 or the like (please refer to FIG. 1). In some examples, sparse projection module 422 may substantially increase the speed of processing such convolutional layers (e.g., by a factor of two) with minimal loss in accuracy (e.g., less than 1%). In some embodiments, camera 400 may not include sparse projection module 422.

In some embodiments, hardware accelerator 402 may implement compression of generated sub-sampled feature maps 412 (e.g., sub-sampled feature maps 412 may be generated based on compression of sub-sampled feature maps generated prior to such compression). Compression module 423 may provide such compression using any suitable technique or techniques. For example, compression module 423 may provide lossless data compression of such convolutional neural network feature maps such as sub-sampled feature maps 412 or the like.

As shown, sub-sampled feature maps 412 may be provided to transmitter 403, which may transmit sub-sampled feature maps 413 to another device (e.g., a gateway or cloud computing device or the like) using any suitable communications channel (e.g., wired or wireless communication) and/or any suitable communications protocol.

As discussed, by implementing a shared or common lower level feature maps format, computational requirements and memory storage requirements of camera 400 may be limited. For example, in some neural network implementations, most of the memory storage may be needed for the fully connected layers. An example distribution of memory storage may include the convolutional layers and subsampling layers requiring 30% of the memory storage and the fully connected layers requiring 70% of the memory storage. Furthermore, as discussed multiple fully connected layers may be implemented, each to perform specific object detection based on the shared or common lower level feature maps format. Therefore, it may be advantageous to distribute lower level layers of the neural network to camera 400 and fully connected portions to cloud computing resources. Such a distribution framework may limit the memory storage requirement of camera 400 while providing broad object detection functionality that may be upgraded or more fully trained via changes implemented at the gateways and/or cloud computing resources discussed herein.

Furthermore, in some embodiments, the model stored at camera 400 (or gateways 202, 302) to implement lower level layers of the distributed neural network may be stored in a 16-bit fixed point, 8-bit fixed point, or quantized representation. Such representations of the model may provide substantial memory storage requirement reductions with similar accuracy (e.g., less than a 1% accuracy drop for 16-bit fixed point representation) with respect to a 32-bit floating point representation of the model. In some examples, the models stored at the gateway and/or the cloud computing resources for the lower level layers (e.g., at the gateway and/or the cloud computing resources) and the fully connected portion (e.g., at the cloud computing resources) may be stored as 32-bit floating point representations of the models as memory storage may not be limited. In some embodiments, a fixed point representation (e.g., a 16-bit fixed point representation) or a quantized representation may be implemented via the distributed camera(s) and floating point representations (e.g., 32-bit floating point representations) may be implemented via the gateway and cloud computing resources.

Such shared or common lower level feature maps format may be implemented using any suitable technique or techniques. For example, the pre-training of the distributed neural network may be performed using a generic model for generic object (e.g., based on a training dataset) to extract the interleaved convolutional layers and sub-sampling (e.g. max-pooling) layers. Such interleaved convolutional layers and sub-sampling layers may be implemented via camera 400 as discussed herein. To train specialized object detection and/or to upgrade or update such specialized object detection, the lower level parameters may be fixed while performing training to higher levels including subsequent lower level interleaved convolutional layers and sub-sampling layers, if any, and fully connected portions of the neural network.

Furthermore, as discussed with respect to FIG. 3, there may be a significant number of cameras per gateway and/or cloud computing resources. In such contexts, limiting the communications bandwidth (e.g., via limiting the size of transmitted sub-sampling feature maps 413) may be advantageous. For example, it may be advantageous to have the bandwidth required by sub-sampling feature maps 413 (e.g., for an image or video frame) to be less than the bandwidth required to send the raw image or video frame via compression and transmission techniques such as the real-time streaming protocol (RTSP) or the like. For example, providing a raw video stream from a 2 megapixel (MP) camera operating at 25 frames per second (FPS) may require a bandwidth of about >8 megabits per second (Mbps) using H.264 video coding (e.g., although some cameras may not yet employ such advanced video coding). In some neural network implementations, transmitting sub-sampling feature maps 413 in less than such a bandwidth may be performed with the fixed point representation model discussed herein (e.g., a 16-bit fixed point representation of the model) and/or sub-sampled feature maps compression techniques discussed herein. Furthermore, in some embodiments, the neural network may have fewer parameters (e.g., smaller sub-sampled feature maps at a second or subsequent combination of convolutional layer and sub-sampling layer, please refer to FIG. 1). In such embodiments, it may be advantageous to implement additional interleaved convolutional layers and sub-sampling layers prior to transmission. In some embodiments, the first two interleaved convolutional layers and sub-sampling layers may be implemented via camera 400, subsequent interleaved convolutional layers and sub-sampling layers may be implemented via a gateway, and the fully connected portion may be implemented via cloud computing resources.

FIG. 5 illustrates an example system 500 for implementing at least a portion of a neural network, arranged in accordance with at least some implementations of the present disclosure. As shown in FIG. 5, system 500 may include a communications interface 501, a processor 502 having lower level layer (LLL) modules 521 and fully connected portion (FCP) modules 522, and a transmitter 503. System 500 may include any suitable system or device having any suitable form factor such as a cloud computing resource, a server, a computer, or the like.

As shown, system 500 may receive feature maps, sub-sampled feature maps (FMs) and/or sensor data (SD) 561, 562 (such as image data) from remote devices 551, 552 via communications interface 501. For example, such feature maps and/or sub-sampled feature maps (FMs) may be any convolutional neural network feature maps or the like as discussed herein. Remote devices 551, 552 may include any type and/or form factor of devices. In some embodiments, remote devices 551, 552 may include sensor modules as discussed herein. In some embodiments, remote devices 551, 552 may include cameras as discussed herein that may provide sub-sampled feature maps and/or image data. In some embodiments, remote devices 551, 552 may include a gateway or the like that may provide sub-sampled feature maps. In some embodiments, remote devices 551, 552 may include cameras that may only provide image data, a memory resource or other device or the like that may provide image data to system 500.

As shown, processor 502 may receive feature maps, sub-sampled feature maps (FMs) and/or sensor data (SD) 511 based on the inputs received at communications interface 501. In examples where processor 502 receives feature maps or sub-sampled feature maps (FMs) or convolutional neural network feature maps or the like that require no additional lower level processing, processor 502 may, via fully connected portion modules 522, apply one or more fully connected portions of neural networks to generate one or more object labels 512. For example, each of fully connected portion modules 522 may apply a specific object detection model to generate specific object detection output labels or the like.

In examples where processor 502 receives feature maps or sub-sampled feature maps (FMs) that require additional lower level processing, processor 502 may, via lower level layer modules 521, apply one or more convolutional layers, sub-sampling layers, or interleaved convolutional layers and sub-sampling layers or the like. Such layers may provide feature maps or sub-sampled feature maps in a common or shared format or in a specialized format. In examples where the feature maps or sub-sampled feature maps are in a common or shared format, processing may continue via fully connected portion modules 522, which may apply one or more fully connected portions of neural networks to generate one or more object labels 512 as discussed above. In examples where the feature maps or sub-sampled feature maps are in a specialized format, an associated specialized fully connected portion module of fully connected portion modules 522 may process the feature maps or sub-sampled feature maps to generate an object label.

In examples where processor 502 receives sensor data such as image data, processor 502 may, via lower level layer modules 521, apply one or more convolutional layers, sub-sampling layers, or interleaved convolutional layers and sub-sampling layers or the like. Such layers may provide feature maps or sub-sampled feature maps in a common or shared format or in a specialized format. In examples where the feature maps or sub-sampled feature maps are in a common or shared format, processing may continue via fully connected portion modules 522, which may apply one or more fully connected portions of neural networks to generate one or more object labels 512 as discussed above. For example, such common format processing may provide advantages such as scalability for system 500. In examples where the feature maps or sub-sampled feature maps are in a specialized format, an associated specialized fully connected portion module of fully connected portion modules 522 may process the feature maps or sub-sampled feature maps to generate an object label.

As shown, such object labels 512 may be provided to transmitter 503, which may transmit object labels 513 to user interface devices or the like as discussed herein. Furthermore, in some examples, system 500 may provide feature maps or sub-sampled feature maps to another device for further processing. In such examples, system 500 may provide gateway functionality as discussed herein.

The discussed techniques may provide distributed neural networks for scalable real-time image and video analytics that advantageously distribute the required computational, memory storage, and transmission bandwidth across heterogeneous devices. Such distributed neural networks may provide sophisticated real-time image and video analytics in real-time.

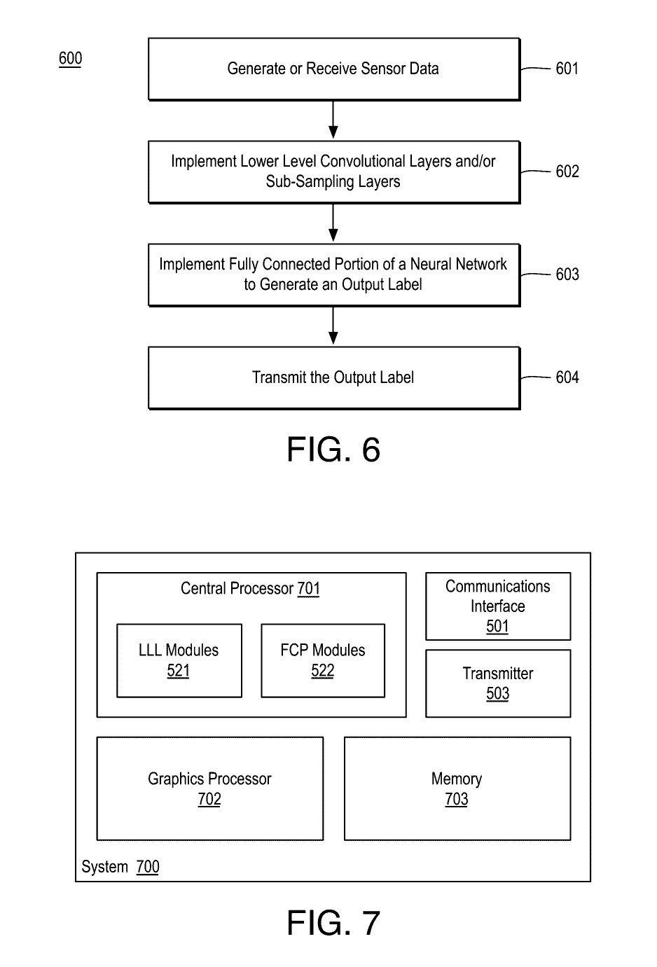

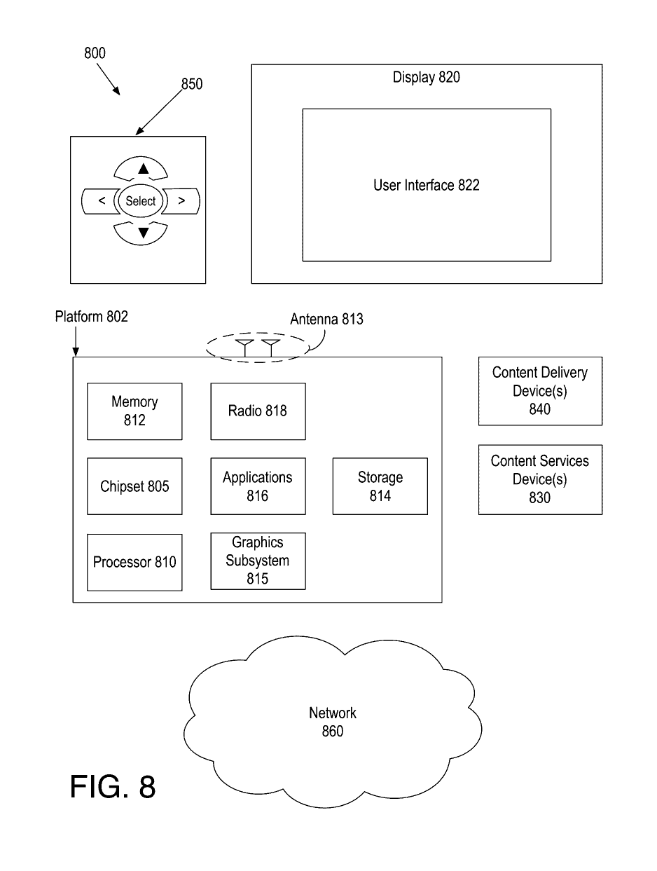

FIG. 6 is a flow diagram illustrating an example process 600 for implementing at least a portion of a neural network, arranged in accordance with at least some implementations of the present disclosure. Process 600 may include one or more operations 601-604 as illustrated in FIG. 6. Process 600 may form at least part of a neural network implementation process. By way of non-limiting example, process 600 may form at least part of a neural network implementation process as performed by any device, system, or combination thereof as discussed herein. Furthermore, process 600 will be described herein with reference to system 700 of FIG. 7, which may perform one or more operations of process 600.

FIG. 7 is an illustrative diagram of an example system 700 for implementing at least a portion of a neural network, arranged in accordance with at least some implementations of the present disclosure. As shown in FIG. 7, system 700 may include a central processor 701, a graphics processor 702, a memory 703, a communications interface 501, and/or a transmitter 503. Also as shown, central processor 701 may include or implement lower level layer modules 521 and fully connected portion modules 522. In the example of system 700, memory 703 may store sensor data, image data, video data, or related content such as input layer data, feature maps, sub-sampled feature maps, neural network parameters or models, object labels, and/or any other data as discussed herein.

As shown, in some examples, lower level layer modules 521 and fully connected portion modules 522 may be implemented via central processor 701. In other examples, one or more or portions of lower level layer modules 521 and fully connected portion modules 522 may be implemented via graphics processor 702, or another processing unit.

Graphics processor 702 may include any number and type of graphics processing units that may provide the operations as discussed herein. Such operations may be implemented via software or hardware or a combination thereof. For example, graphics processor 702 may include circuitry dedicated to manipulate image data, neural network data, or the like obtained from memory 703. Central processor 701 may include any number and type of processing units or modules that may provide control and other high level functions for system 700 and/or provide any operations as discussed herein. Memory 703 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 703 may be implemented by cache memory.

In an embodiment, lower level layer modules 521 and fully connected portion modules 522 or portions thereof may be implemented via an execution unit (EU) of graphics processor 702. The EU may include, for example, programmable logic or circuitry such as a logic core or cores that may provide a wide array of programmable logic functions. In an embodiment, lower level layer modules 521 and fully connected portion modules 522 or portions thereof may be implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 6, process 600 may begin at operation 601, “Generate or Receive Sensor Data”, where sensor data such as image data or the like may be generated or received. Such sensor data may be generated or received using any suitable technique or techniques. In some embodiments, sensor data may be generated via a sensor module or the like implemented via a device. In some embodiments, sensor data may include area monitoring data, environmental monitoring data, industrial monitoring data, or the like. In some embodiments, image data may be generated via camera module 211 of camera 201, camera module 311 of any of cameras 301, camera module 401 of camera 400, or the like. In some embodiments, image data may be received via gateway 202, gateway 302, cloud computing resource 203, any of cloud computing resources 303, system 500, or the like. In some embodiments, image data may be received via communications interface 501 of system 700.

Processing may continue at operation 602, “Implement Lower Level Convolutional Layers and/or Sub-Sampling Layers”, where lower level convolutional layers and/or sub-sampling layers may be implemented based on the image data to generate one or more convolutional neural network feature maps (e.g., including feature maps or sub-sampled feature maps). The lower level convolutional layers and/or sub-sampling layers may be implemented via any suitable technique or techniques such as those discussed herein. In some examples, the lower level convolutional layers and/or sub-sampling layers may generate convolutional neural network feature maps having a shared lower level convolutional neural network feature maps format.

In some embodiments, one or more interleaved convolutional layers and sub-sampling layers may be implemented via lower level layer module 212 of camera 201, lower level layer module 312 of any of cameras 301, lower level layer module 421 as implemented via hardware accelerator 402 of camera 400, lower level layer module 221 of gateway 202, any of lower level layer modules 321 of gateway 302, lower level layer module 231 of cloud computing resource 203, any of lower level layer modules 331 of any of cloud computing resources 303, any of lower level layer modules 521 of system 500, or any of lower level layer modules 521 as implemented via central processor 701 of system 700, or any combination thereof.

Processing may continue at operation 603, “Implement Fully Connected Portion of a Neural Network to Generate an Output Label”, where a fully connected portion of a neural network may be implemented to generate an output label. The fully connected portion of a neural network may be implemented using any suitable technique or techniques. In some embodiments, the fully connected portion may be implemented via fully connected portion module 232 of cloud computing resource 203, any of fully connected portion modules 332 of any of cloud computing resources 303, any of fully connected portion modules 521 as implemented via processor 502 of system 500 or as implemented via central processor 701 of system 700, or the like. For example, the fully connected portion of the neural network may include a specialized fully connected portion to perform a specific object detection.

In some embodiments, a second fully connected portion of a neural network may be implemented based on the convolutional neural network feature maps such that the fully connected portion and the second fully connected portion are different. For example, the fully connected portions may each perform a specific object detection such as face detection, pedestrian detection, auto detection, license plate detection, or the like. In some embodiments, the fully connected portions may each perform at least part of a segmentation, a detection or a recognition task, Furthermore, as discussed herein, in some embodiments, the lower level convolutional neural network layer may include a fixed point representation (e.g., a 16-bit fixed point representation) or a quantized representation and the fully connected portion of the neural network may include a floating point representation (e.g., a 32-bit floating point representation).

Processing may continue at operation 604, “Transmit the Output Label”, where the output label may be transmitted. The output label may be transmitted using any suitable technique or techniques. In some embodiments, cloud computing resource 203 may transmit the output label to user interface device 204, any of cloud computing resources 303 may transmit the output label to any of user interface devices 304, transmitter 503 as implemented via system 500 or system 700 may transmit the output label, or the like.

Process 600 may be repeated any number of times either in series or in parallel for any number input images (e.g., still images or video frames) or the like. For example, process 600 may provide for the implementation of a scalable end-to-end heterogeneously distributed neural network framework. Process 600 may provide a wide range of processing and communications options for generating and/or communicating image data, implementing lower level convolutional layers and/or sub-sampling layers, communicating the resultant convolutional neural network feature maps (e.g., including feature maps or sub-sampled feature maps), implementing further lower level convolutional layers and/or sub-sampling layers, communicating the resultant convolutional neural network feature maps based on such further processing, implementing fully connected portions of a neural network to generate a neural network output label or labels, and communicating the resultant output label or labels.

In some embodiments, a camera module of a device such as a camera may generate image data (e.g., as discussed with respect to operation 601). A hardware accelerator of the device may implement at least one convolutional layer and at least one sub-sampling layer of a lower level of a convolutional neural network to generate one or more convolutional neural network feature maps based on the image data (e.g., as discussed with respect to operation 601). For example, the device may be an internet protocol camera and the hardware accelerator may be a graphics processor, a digital signal processor a field-programmable gate array, an application specific integrated circuit, or the like. In some embodiments, the one or more convolutional neural network feature maps comprise a shared lower level feature maps format. In some embodiments, the hardware accelerator may implement sparse projection to implement the at least one convolutional layer of the convolutional neural network. In some embodiments, the hardware accelerator may perform compression of the one or more sub-sampled feature maps prior to transmission of the one or more sub-sampled feature maps. Furthermore, the device may include a transmitter to transmit the one or more sub-sampled feature maps to a receiving device. For example, the receiving device may be a gateway, a cloud computing resource, or the like.

In some embodiments, one or more convolutional neural network feature maps may be received via a device or system such as a gateway or a cloud computing resource. In some embodiments, the one or more convolutional neural network feature maps may be received from an internet protocol camera or a gateway at a cloud computing resource. For example, communications interface 501 as implemented via system 700 may receive one or more convolutional neural network feature maps. In some embodiments, the device or system may include a processor to implement at least a fully connected portion of a neural network to generate a neural network output label based on the one or more convolutional neural network feature maps (e.g., as discussed with respect to operation 603). For example, any of fully connected portion modules 522 as implemented via central processor 701 may generate the neural network output label based on the one or more convolutional neural network feature maps. In some embodiments, the processor may further implement one or more lower level convolutional neural network layers prior to the implementation of the fully connected portion of the neural network. For example, any of lower level layer modules 521 as implemented via central processor 701 may implement one or more lower level convolutional neural network layers prior to the implementation of the fully connected portion of the neural network.

As discussed, in some embodiments, the one or more convolutional neural network feature maps comprise a shared lower level feature maps format. In some embodiments, the device or system may also receive one or more second convolutional neural network feature maps having a same format as the one or more convolutional neural network feature maps. The device or system may implement at least a second fully connected portion of a second neural network to generate a second neural network output label based on the one or more second convolutional neural network feature maps such that the fully connected portion of the neural network and the second fully connected portion of the second neural network comprise different fully connected portions. For example, the fully connected portions may perform specific object detection as discussed herein.

Various components of the systems described herein may be implemented in software, firmware, and/or hardware and/or any combination thereof. For example, various components of the systems discussed herein may be provided, at least in part, by hardware of a computing System-on-a-Chip (SoC) such as may be found in a computing system such as, for example, a smartphone. Those skilled in the art may recognize that systems described herein may include additional components that have not been depicted in the corresponding figures. For example, the systems discussed herein may include additional components such as communications modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the systems discussed herein or any other module or component as discussed herein.

As used in any implementation described herein, the term “module” or “component” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

FIG. 8 is an illustrative diagram of an example system 800, arranged in accordance with at least some implementations of the present disclosure. In various implementations, system 800 may be a mobile system although system 800 is not limited to this context. System 800 may implement and/or perform any modules or techniques discussed herein. For example, system 800 may be incorporated into a personal computer (PC), sever, laptop computer, ultra-laptop computer, tablet, touch pad, portable computer, handheld computer, palmtop computer, personal digital assistant (PDA), cellular telephone, combination cellular telephone/PDA, television, smart device (e.g., smartphone, smart tablet or smart television), mobile internet device (MID), messaging device, data communication device, cameras (e.g. point-and-shoot cameras, super-zoom cameras, digital single-lens reflex (DSLR) cameras), and so forth. In some examples, system 800 may be implemented via a cloud computing environment.

In various implementations, system 800 includes a platform 802 coupled to a display 820. Platform 802 may receive content from a content device such as content services device(s) 830 or content delivery device(s) 840 or other similar content sources. A navigation controller 850 including one or more navigation features may be used to interact with, for example, platform 802 and/or display 820. Each of these components is described in greater detail below.

In various implementations, platform 802 may include any combination of a chipset 805, processor 810, memory 812, antenna 813, storage 814, graphics subsystem 815, applications 816 and/or radio 818. Chipset 805 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor 810 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 810 may be dual-core processor(s), dual-core mobile processor(s), and so forth.

Memory 812 may be implemented as a volatile memory device such as, but not limited to, a Random Access Memory (RAM), Dynamic Random Access Memory (DRAM), or Static RAM (SRAM).

Storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 814 may include technology to increase the storage performance enhanced protection for valuable digital media when multiple hard drives are included, for example.

Graphics subsystem 815 may perform processing of images such as still or video for display. Graphics subsystem 815 may be a graphics processing unit (GPU) or a visual processing unit (VPU), for example. An analog or digital interface may be used to communicatively couple graphics subsystem 815 and display 820. For example, the interface may be any of a High-Definition Multimedia Interface, DisplayPort, wireless HDMI, and/or wireless HD compliant techniques. Graphics subsystem 815 may be integrated into processor 810 or chipset 805. In some implementations, graphics subsystem 815 may be a stand-alone device communicatively coupled to chipset 805.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 818 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 818 may operate in accordance with one or more applicable standards in any version.

In various implementations, display 820 may include any television type monitor or display. Display 820 may include, for example, a computer display screen, touch screen display, video monitor, television-like device, and/or a television. Display 820 may be digital and/or analog. In various implementations, display 820 may be a holographic display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display user interface 822 on display 820.

In various implementations, content services device(s) 830 may be hosted by any national, international and/or independent service and thus accessible to platform 802 via the Internet, for example. Content services device(s) 830 may be coupled to platform 802 and/or to display 820. Platform 802 and/or content services device(s) 830 may be coupled to a network 860 to communicate (e.g., send and/or receive) media information to and from network 860. Content delivery device(s) 840 also may be coupled to platform 802 and/or to display 820.

In various implementations, content services device(s) 830 may include a cable television box, personal computer, network, telephone, Internet enabled devices or appliance capable of delivering digital information and/or content, and any other similar device capable of uni-directionally or bi-directionally communicating content between content providers and platform 802 and/display 820, via network 860 or directly. It will be appreciated that the content may be communicated uni-directionally and/or bi-directionally to and from any one of the components in system 800 and a content provider via network 860. Examples of content may include any media information including, for example, video, music, medical and gaming information, and so forth.

Content services device(s) 830 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 802 may receive control signals from navigation controller 850 having one or more navigation features. The navigation features of navigation controller 850 may be used to interact with user interface 822, for example. In various embodiments, navigation controller 850 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 850 may be replicated on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In various embodiments, navigation controller 850 may not be a separate component but may be integrated into platform 802 and/or display 820. The present disclosure, however, is not limited to the elements or in the context shown or described herein.

In various implementations, drivers (not shown) may include technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 even when the platform is turned “off” In addition, chipset 805 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the present disclosure.

In various embodiments, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

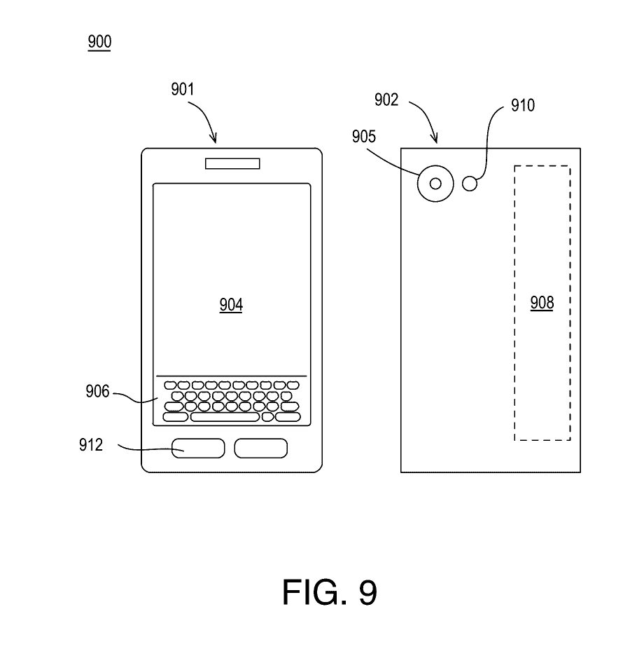

As described above, system 800 may be embodied in varying physical styles or form factors. FIG. 9 illustrates an example small form factor device 900, arranged in accordance with at least some implementations of the present disclosure. In some examples, system 800 may be implemented via device 900. In other examples, other systems discussed herein or portions thereof may be implemented via device 900. In various embodiments, for example, device 900 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smartphone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smartphone capable of executing computer applications, as well as voice communications and/or data communications. Although some embodiments may be described with a mobile computing device implemented as a smartphone by way of example, it may be appreciated that other embodiments may be implemented using other wireless mobile computing devices as well. The embodiments are not limited in this context.

As shown in FIG. 9, device 900 may include a housing with a front 901 and a back 902. Device 900 includes a display 904, an input/output (I/O) device 906, and an integrated antenna 908. Device 900 also may include navigation features 912. I/O device 906 may include any suitable I/O device for entering information into a mobile computing device. Examples for I/O device 906 may include an alphanumeric keyboard, a numeric keypad, a touch pad, input keys, buttons, switches, microphones, speakers, voice recognition device and software, and so forth. Information also may be entered into device 900 by way of microphone (not shown), or may be digitized by a voice recognition device. As shown, device 900 may include a camera 905 (e.g., including a lens, an aperture, and an imaging sensor) and a flash 910 integrated into back 902 (or elsewhere) of device 900. In other examples, camera 905 and flash 910 may be integrated into front 901 of device 900 or both front and back cameras may be provided. Camera 905 and flash 910 may be components of a camera module to originate image data processed into streaming video that is output to display 904 and/or communicated remotely from device 900 via antenna 908 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a computer-implemented method for implementing a neural network via a device comprises receiving, via a communications interface at the device, one or more convolutional neural network feature maps generated via a second device, implementing, via the device, at least a fully connected portion of the neural network to generate a neural network output label based on the one or more feature maps, and transmitting the neural network output label.

Further to the first embodiments, the method further comprises implementing, via the device, one or more lower level convolutional neural network layers prior to implementing the fully connected portion of the neural network.

Further to the first embodiments, the method further comprises receiving, via the communications interface at the device, one or more second convolutional neural network feature maps having a same format as the one or more convolutional neural network feature maps and implementing, via the device, at least a second fully connected portion of a second neural network to generate a second neural network output label based on the one or more second feature maps, wherein the fully connected portion of the neural network and the second fully connected portion of the second neural network comprise different fully connected portions.

Further to the first embodiments, the method further comprises receiving, via the communications interface at the device, one or more second convolutional neural network feature maps having a same format as the one or more convolutional neural network feature maps and implementing, via the device, at least a second fully connected portion of a second neural network to generate a second neural network output label based on the one or more second feature maps, wherein the fully connected portion of the neural network and the second fully connected portion of the second neural network comprise different fully connected portions, wherein the one or more second convolutional neural network feature maps are received via a third device, wherein the second device comprises an internet protocol camera and the third device comprises at least one of an internet protocol camera or a gateway.

Further to the first embodiments, the method further comprises receiving, via the communications interface at the device, one or more second convolutional neural network feature maps having a same format as the one or more convolutional neural network feature maps and implementing, via the device, at least a second fully connected portion of a second neural network to generate a second neural network output label based on the one or more second feature maps, wherein the fully connected portion of the neural network and the second fully connected portion of the second neural network comprise different fully connected portions, wherein the fully connected portion of the neural network is to perform at least part of a segmentation, a detection or a recognition task and the second fully connected portion of the second neural network is to perform at least part of a second segmentation, a second detection or a second recognition task.

Further to the first embodiments, the one or more convolutional neural network feature maps comprise a shared lower level convolutional neural network feature maps format and the fully connected portion of the neural network comprises a specialized fully connected portion to perform a specific object detection.

Further to the first embodiments, the method further comprises implementing, via the second device, at least one lower level convolutional neural network layer to generate the one or more convolutional neural network feature maps and transmitting the one or more convolutional neural network feature maps to the device.

Further to the first embodiments, the method further comprises implementing, via the second device, at least one lower level convolutional neural network layer to generate the one or more convolutional neural network feature maps and transmitting the one or more convolutional neural network feature maps to the device, wherein the second device comprises at least one of an internet protocol camera or a gateway.

Further to the first embodiments, the method further comprises implementing, via the second device, at least one lower level convolutional neural network layer to generate the one or more convolutional neural network feature maps and transmitting the one or more convolutional neural network feature maps to the device, wherein the lower level convolutional neural network layer comprises at least one of a fixed point representation or a quantized representation and the fully connected portion of the neural network comprises a floating point representation.

Further to the first embodiments, the method further comprises receiving, at the second device, one or more second convolutional neural network feature maps generated via a third device and implementing, via the second device, at least one lower level convolutional neural network layer to generate the one or more convolutional neural network feature maps, wherein the device comprises a cloud computing resource, the second device comprises a gateway, and the third device comprises an internet protocol camera.

In one or more second embodiments, a device comprises a sensor to generate sensor data, a hardware accelerator to implement at least one convolutional layer and at least one sub-sampling layer of a lower level of a convolutional neural network to generate one or more convolutional neural network feature maps based on the sensor data, and a transmitter to transmit the one or more convolutional neural network feature maps to a receiving device.

Further to the second embodiments, the device comprises an internet protocol camera and the hardware accelerator comprises at least one of a graphics processor, a digital signal processor a field-programmable gate array, or an application specific integrated circuit.

Further to the second embodiments, the one or more convolutional neural network feature maps comprise a shared lower level feature maps format.

Further to the second embodiments, the hardware accelerator is to implement sparse projection to implement the at least one convolutional layer of the convolutional neural network.

Further to the second embodiments, the hardware accelerator is to perform compression of the one or more sub-sampled feature maps prior to transmission of the one or more sub-sampled feature maps.

Further to the second embodiments, the hardware accelerator is to implement sparse projection to implement the at least one convolutional layer of the convolutional neural network and/or the hardware accelerator is to perform compression of the one or more sub-sampled feature maps prior to transmission of the one or more sub-sampled feature maps.

In one or more third embodiments, system for implementing a neural network comprises a communications interface to receive one or more convolutional neural network feature maps generated via a remote device and a processor to implement at least a fully connected portion of a neural network to generate a neural network output label based on the one or more convolutional neural network feature maps.

Further to the third embodiments, the processor is further to implement one or more lower level convolutional neural network layers prior to the implementation of the fully connected portion of the neural network.

Further to the third embodiments, the communications interface is to receive one or more second convolutional neural network feature maps having a same format as the one or more convolutional neural network feature maps and the processor is to implement at least a second fully connected portion of a second neural network to generate a second neural network output label based on the one or more second convolutional neural network feature maps, wherein the fully connected portion of the neural network and the second fully connected portion of the second neural network comprise different fully connected portions.

Further to the third embodiments, the communications interface is to receive one or more second convolutional neural network feature maps having a same format as the one or more convolutional neural network feature maps and the processor is to implement at least a second fully connected portion of a second neural network to generate a second neural network output label based on the one or more second convolutional neural network feature maps, wherein the fully connected portion of the neural network and the second fully connected portion of the second neural network comprise different fully connected portions, wherein the one or more second convolutional neural network feature maps are received via a second remote device, wherein the remote device comprises an internet protocol camera and the second remote device comprises at least one of an internet protocol camera or a gateway.

Further to the third embodiments, the communications interface is to receive one or more second convolutional neural network feature maps having a same format as the one or more convolutional neural network feature maps and the processor is to implement at least a second fully connected portion of a second neural network to generate a second neural network output label based on the one or more second convolutional neural network feature maps, wherein the fully connected portion of the neural network and the second fully connected portion of the second neural network comprise different fully connected portions, wherein the fully connected portion of the neural network is to perform at least part of a segmentation, a detection or a recognition task and the second fully connected portion of the second neural network is to perform at least part of a second segmentation, a second detection or a second recognition task.

Further to the third embodiments, the one or more convolutional neural network feature maps comprise a shared lower level convolutional neural network feature maps format and the fully connected portion of the neural network comprises a specialized fully connected portion to perform a specific object detection.

Further to the third embodiments, the system further comprises the remote device to implement at least one lower level convolutional neural network layer to generate the one or more convolutional neural network feature maps and to transmit the one or more convolutional neural network feature maps to the device, wherein the one or more convolutional neural network feature maps comprise a shared lower level convolutional neural network feature maps format and the fully connected portion of the neural network comprises a specialized fully connected portion to perform a specific object detection.

In one or more fourth embodiments, a system for implementing a neural network comprises means for receiving one or more convolutional neural network feature maps generated via a second device, means for implementing at least a fully connected portion of the neural network to generate a neural network output label based on the one or more feature maps, and means for transmitting the neural network output label.

Further to the fourth embodiments, the system further comprises means for implementing one or more lower level convolutional neural network layers prior to implementing the fully connected portion of the neural network.

Further to the fourth embodiments, the system further comprises means for receiving one or more second convolutional neural network feature maps having a same format as the one or more convolutional neural network feature maps and means for implementing at least a second fully connected portion of a second neural network to generate a second neural network output label based on the one or more second feature maps, wherein the fully connected portion of the neural network and the second fully connected portion of the second neural network comprise different fully connected portions.

Further to the fourth embodiments, means for implementing at least a second fully connected portion of a second neural network to generate a second neural network output label based on the one or more second feature maps, wherein the fully connected portion of the neural network and the second fully connected portion of the second neural network comprise different fully connected portions, wherein the fully connected portion of the neural network is to perform at least part of a segmentation, a detection or a recognition task and the second fully connected portion of the second neural network is to perform at least part of a second segmentation, a second detection or a second recognition task.

Further to the fourth embodiments, the one or more convolutional neural network feature maps comprise a shared lower level convolutional neural network feature maps format and the fully connected portion of the neural network comprises a specialized fully connected portion to perform a specific object detection.

In one or more fifth embodiments, at least one machine readable medium comprises a plurality of instructions that, in response to being executed on a device, cause the device to implement a neural network by receiving, via a communications interface at the device, one or more convolutional neural network feature maps generated via a second device, implementing, via the device, at least a fully connected portion of the neural network to generate a neural network output label based on the one or more feature maps, and transmitting the neural network output label.

Further to the fifth embodiments, the machine readable medium further comprises instructions that, in response to being executed on the device, cause the device to implement the neural network by implementing, via the device, one or more lower level convolutional neural network layers prior to implementing the fully connected portion of the neural network.

Further to the fifth embodiments, the machine readable medium further comprises instructions that, in response to being executed on the device, cause the device to implement the neural network by receiving, via the communications interface at the device, one or more second convolutional neural network feature maps having a same format as the one or more convolutional neural network feature maps and implementing, via the device, at least a second fully connected portion of a second neural network to generate a second neural network output label based on the one or more second feature maps, wherein the fully connected portion of the neural network and the second fully connected portion of the second neural network comprise different fully connected portions.

Further to the fifth embodiments, the machine readable medium further comprises instructions that, in response to being executed on the device, cause the device to implement the neural network by receiving, via the communications interface at the device, one or more second convolutional neural network feature maps having a same format as the one or more convolutional neural network feature maps and implementing, via the device, at least a second fully connected portion of a second neural network to generate a second neural network output label based on the one or more second feature maps, wherein the fully connected portion of the neural network and the second fully connected portion of the second neural network comprise different fully connected portions, wherein the fully connected portion of the neural network is to perform at least part of a segmentation, a detection or a recognition task and the second fully connected portion of the second neural network is to perform at least part of a second segmentation, a second detection or a second recognition task.

Further to the fifth embodiments, the one or more convolutional neural network feature maps comprise a shared lower level convolutional neural network feature maps format and the fully connected portion of the neural network comprises a specialized fully connected portion to perform a specific object detection.

In one or more sixth embodiments, at least one machine readable medium may include a plurality of instructions that in response to being executed on a computing device, causes the computing device to perform a method according to any one of the above embodiments.

In one or more seventh embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A computer-implemented method for implementing a neural network via a device comprising:
receiving, via a communications interface at the device, one or more convolutional neural network feature maps generated via a second device;
implementing, via the device, at least a fully connected portion of the neural network to generate a neural network output label based on the one or more feature maps; and
transmitting the neural network output label.

2. The method of claim 1, further comprising:
implementing, via the device, one or more lower level convolutional neural network layers prior to implementing the fully connected portion of the neural network.

3. The method of claim 1, further comprising:
receiving, via the communications interface at the device, one or more second convolutional neural network feature maps having a same format as the one or more convolutional neural network feature maps; and
implementing, via the device, at least a second fully connected portion of a second neural network to generate a second neural network output label based on the one or more second feature maps, wherein the fully connected portion of the neural network and the second fully connected portion of the second neural network comprise different fully connected portions.

4. The method of claim 3, wherein the one or more second convolutional neural network feature maps are received via a third device, wherein the second device comprises an internet protocol camera and the third device comprises at least one of an internet protocol camera or a gateway.

5. The method of claim 3, wherein the fully connected portion of the neural network is to perform at least part of a segmentation, a detection or a recognition task and the second fully connected portion of the second neural network is to perform at least part of a second segmentation, a second detection or a second recognition task.

6. The method of claim 1, wherein the one or more convolutional neural network feature maps comprise a shared lower level convolutional neural network feature maps format and the fully connected portion of the neural network comprises a specialized fully connected portion to perform a specific object detection.

7. The method of claim 1, further comprising:
implementing, via the second device, at least one lower level convolutional neural network layer to generate the one or more convolutional neural network feature maps; and
transmitting the one or more convolutional neural network feature maps to the device.

8. The method of claim 7, wherein the second device comprises at least one of an internet protocol camera or a gateway.

9. The method of claim 7, wherein the lower level convolutional neural network layer comprises at least one of a fixed point representation or a quantized representation and the fully connected portion of the neural network comprises a floating point representation.

10. The method of claim 1, further comprising:
receiving, at the second device, one or more second convolutional neural network feature maps generated via a third device; and
implementing, via the second device, at least one lower level convolutional neural network layer to generate the one or more convolutional neural network feature maps, wherein the device comprises a cloud computing resource, the second device comprises a gateway, and the third device comprises an internet protocol camera.

11. A device comprising:
a sensor to generate sensor data;
a hardware accelerator to implement at least one convolutional layer and at least one sub-sampling layer of a lower level of a convolutional neural network to generate one or more convolutional neural network feature maps based on the sensor data; and
a transmitter to transmit the one or more convolutional neural network feature maps to a receiving device.

12. The device of claim 11, wherein the device comprises an internet protocol camera and the hardware accelerator comprises at least one of a graphics processor, a digital signal processor a field-programmable gate array, or an application specific integrated circuit.

13. The device of claim 11, wherein the one or more convolutional neural network feature maps comprise a shared lower level feature maps format.

14. The device of claim 11, wherein the hardware accelerator is to implement sparse projection to implement the at least one convolutional layer of the convolutional neural network.

15. The device of claim 11, wherein the hardware accelerator is to perform compression of the one or more sub-sampled feature maps prior to transmission of the one or more sub-sampled feature maps.

16. A system for implementing a neural network comprising:
a communications interface to receive one or more convolutional neural network feature maps generated via a remote device; and
a processor to implement at least a fully connected portion of a neural network to generate a neural network output label based on the one or more convolutional neural network feature maps.

17. The system of claim 16, wherein the processor is further to implement one or more lower level convolutional neural network layers prior to the implementation of the fully connected portion of the neural network.

18. The system of claim 16, wherein the communications interface is to receive one or more second convolutional neural network feature maps having a same format as the one or more convolutional neural network feature maps and the processor is to implement at least a second fully connected portion of a second neural network to generate a second neural network output label based on the one or more second convolutional neural network feature maps, wherein the fully connected portion of the neural network and the second fully connected portion of the second neural network comprise different fully connected portions.

19. The system of claim 18, wherein the one or more second convolutional neural network feature maps are received via a second remote device, wherein the remote device comprises an internet protocol camera and the second remote device comprises at least one of an internet protocol camera or a gateway.

20. The system of claim 16, further comprising the remote device to implement at least one lower level convolutional neural network layer to generate the one or more convolutional neural network feature maps and to transmit the one or more convolutional neural network feature maps to the device, wherein the one or more convolutional neural network feature maps comprise a shared lower level convolutional neural network feature maps format and the fully connected portion of the neural network comprises a specialized fully connected portion to perform a specific object detection.

21. At least one machine readable medium comprising a plurality of instructions that, in response to being executed on a device, cause the device to implement a neural network by:
receiving, via a communications interface at the device, one or more convolutional neural network feature maps generated via a second device;
implementing, via the device, at least a fully connected portion of the neural network to generate a neural network output label based on the one or more feature maps; and
transmitting the neural network output label.

22. The machine readable medium of claim 21, further comprising instructions that, in response to being executed on the device, cause the device to implement the neural network by:
implementing, via the device, one or more lower level convolutional neural network layers prior to implementing the fully connected portion of the neural network.

23. The machine readable medium of claim 21, further comprising instructions that, in response to being executed on the device, cause the device to implement the neural network by:
receiving, via the communications interface at the device, one or more second convolutional neural network feature maps having a same format as the one or more convolutional neural network feature maps; and
implementing, via the device, at least a second fully connected portion of a second neural network to generate a second neural network output label based on the one or more second feature maps, wherein the fully connected portion of the neural network and the second fully connected portion of the second neural network comprise different fully connected portions.

24. The machine readable medium of claim 23, wherein the fully connected portion of the neural network is to perform at least part of a segmentation, a detection or a recognition task and the second fully connected portion of the second neural network is to perform at least part of a second segmentation, a second detection or a second recognition task.

25. The machine readable medium of claim 21, wherein the one or more convolutional neural network feature maps comprise a shared lower level convolutional neural network feature maps format and the fully connected portion of the neural network comprises a specialized fully connected portion to perform a specific object detection.
